(19) United States
(12) Patent Application Publication
(10) Pub. No.: US 2017/0132679 A1
(43) Pub. Date: May 11, 2017

(54) Systems and Processes for Anonymously and Confidentially Introducing One or More Potential Purchasers of an Unlisted Real Property to the Owner of that Property

(71) Applicant: Covet, Inc., Wasington, CT (US)

(72) Inventors: Michael Lind, Washington, CT (US); Caroline Lind, Washington, CT (US)

(73) Assignee: Covet, Inc., Washington, CT (US)

(21) Appl. No.: 14/933,989

(22) Filed: Nov. 5, 2015

(51) Int. Cl. G06Q 30/06; G06Q 50/16

(52) U.S. Cl. CPC G06Q 30/0609; G06Q 50/167; G06Q 30/0615

(57) ABSTRACT

An exchange platform comprised of systems and processes for anonymously and confidentially introducing one or more potential purchasers of an unlisted real property to the owner of that property are disclosed. A computer-implemented method comprises (i) receiving identification data with respect to one or more unlisted real properties of interest from a potential purchaser of those properties via a client application; (ii) creating a confidential list for the potential purchaser consisting of all or a selected subset of the unlisted real properties for which property identification data was received from the potential purchaser; (iii) receiving property registrations from owners of unlisted real properties via a client application; and (iv) matching property identification data from property registrations against property identification data from the confidential list (and the confidential lists of other potential purchasers). If and when a match occurs, a matching notification is generated and the matching notification is transmitted to the owner of the matched property. A matching notification informs the owner of a potential purchaser's interest in purchasing the owner's property. At the owner's discretion, anonymous e-mail communication is then enabled between the owner and the potential purchaser.

### FIELD OF THE INVENTION

The present disclosure relates to computer systems. More particularly, the present disclosure describes an exchange platform comprised of systems and processes for anonymously and confidentially introducing one or more potential purchasers of an unlisted real property to the owner of that property, for the purpose of triggering and facilitating transaction negotiations with respect to that property.

### BACKGROUND

In English common law, real property, real estate, realty, or immovable property is any subset of land (including any natural resources thereupon) that has been legally defined and the improvements to it that have been made by human efforts such as structures, machinery, wells, dams, ponds, mines, canals, roads, etc. Real property and personal property are the two main subunits of property in English common law. Real property may be grouped into four principal categories: residential, commercial, industrial and agricultural. Residential real estate might include land that is undeveloped but zoned for residences or land with existing residential improvements such as houses, condominiums, townhomes, and apartments. Commercial real estate might include land that is undeveloped but zoned for commercial uses or land with existing commercial improvements such as office buildings, warehouses or retailing structures. Industrial real estate might include land that is undeveloped but zoned for industrial uses or land that includes existing improvements for industrial uses such as manufacturing or mining. Finally, agricultural real estate might include land that is undeveloped but zoned for the production of crops (including timber) or land currently producing crops.

Prior methods of introducing potential purchasers of unlisted real properties to the owners of those properties, such as those prior methods typically employed in the purchase and sale of residential real estate, may be grouped into two principal categories: third-party introductions and for-sale-by-owner (“FSBO”) introductions. In the case of third-party introductions, a seller retains a licensed real estate broker to serve as his or her agent and intermediary in all aspects of the marketing of the seller's property. The seller typically enters into a listing agreement with a listing broker whereby the seller agrees to pay the listing broker a commission (typically 6% of the sale proceeds) upon closing the sale of the subject property. The listing broker, through its membership in a Multiple Listing Service (“MLS”) agrees, in turn, to protect other brokers with a commission split in exchange for introducing a potential purchaser who ultimately purchases the subject property. In the case of FSBO introductions, a seller undertakes the marketing of his or her property without the assistance of a broker or an MLS. As there is no listing broker associated with a FSBO property, there is no commission payable to a listing broker. A FSBO seller, however, may agree to pay a partial commission to a purchaser's broker who introduces a potential purchaser who ultimately purchases the subject property.

Other, less common, prior methods of introducing potential purchasers of residential properties to the owners of those properties might include auctions, typically associated with distressed or foreclosed properties; and so-called pocket-listings, whereby a seller enters into an informal commission agreement with a listing broker pursuant to which the listing broker agrees not to publish (or to delay publishing) the subject property's listing on an MLS.

Prior methods of introducing potential purchasers of unlisted real properties to the owners of those properties, such as those prior methods described above, require a property owner to publicly declare himself or herself a property seller, create a listing describing the subject property, publish the listing in a variety of digital and physical formats and proactively solicit purchaser interest in the listing and property through advertisements, open-houses, yard signs and other undertakings. The prior methods expose the seller and the seller's listing not only to potential purchasers, but to brokers and the general public as well, and is generally considered to be a necessary, but intrusive process.

Prior methods of introducing potential purchasers of unlisted real properties to the owners of those properties, such as those prior methods described above, exclude from the marketplace the large percentage of property owners who are in fact potential sellers, but who require an impetus to cross the emotional Rubicon associated with the decision to sell their respective properties. Specifically, the prior methods do not allow potential purchaser interest in an unlisted real property to serve as the catalyst for converting a fence-sitting owner of a property into a seller of that property.

Prior methods of introducing potential purchasers of unlisted real properties to the owners of those properties, such as those prior methods described above, also exclude from the marketplace privacy-conscious owners who, although they may wish to sell, are reluctant to expose themselves to the invasion of privacy inherent in the prior methods. Accordingly, the prior methods actually have the effect of constraining the pool of purchasable properties.

Prior methods of introducing potential purchasers of unlisted real properties to the owners of those properties, such as those prior methods described above, require a potential purchaser or a potential purchaser's broker to search existing property listings and respond to the listing broker or FSBO Owner, as the case may be. Accordingly, the prior methods limit a potential purchaser's choices to those properties which have been publicly listed previously by a listing broker or a FSBO owner.

### SUMMARY

An exchange platform comprised of systems and processes for anonymously and confidentially introducing one or more potential purchasers of an unlisted real property to the owner of that property are disclosed. A computer-implemented method comprises (i) receiving identification data with respect to one or more unlisted real properties of interest from a potential purchaser of those properties via a client application; (ii) creating a confidential list for the potential purchaser consisting of all or a selected subset of the unlisted real properties for which property identification data was received from the potential purchaser; (iii) receiving property registrations from owners of unlisted real properties via a client application; and (iv) matching property identification data from property registrations against property identification data from the confidential list (and the confidential lists of other potential purchasers). If and when a match occurs, a matching notification is generated and the matching notification is transmitted to the owner of the matched property. A matching notification informs the owner of a potential purchaser's interest in purchasing the owner's property. At the owner's discretion, anonymous e-mail communication is then enabled between the owner and the potential purchaser.

### BRIEF DESCRIPTIONS OF DRAWINGS

FIG. 1a is a flow chart of an exemplary embodiment of a present platform process to (i) allow potential purchasers to capture data (such as street addresses, notes, and photographs) with respect to unlisted real properties of interest and (ii) cache the data in a pending state.

FIG. 1b is a flow chart of an exemplary embodiment of a present platform process to (i) verify the identity of a user (in this instance a potential purchaser); (ii) allow the potential purchaser to create one or more confidential list(s) of unlisted real properties; (iii) allow the potential purchaser to populate his or her confidential list(s) with those captured unlisted real properties that the potential purchaser has decided to pursue; (iv) automatically notify the owner of a registered unlisted real property if and when his or her property has been added to one or more of the confidential list(s); and (v) invite the owner of an unregistered unlisted real property that has been added to one or more of the confidential list(s) to visit the present platform and register the property.

FIG. 1c is a flow chart of an exemplary embodiment of a present platform process to (i) create or update a confidential buyer profile having supporting documents and other information uploaded by a potential purchaser and (ii) automatically generate or update a metric that scores the completeness of that confidential buyer profile.

FIG. 2a is a flow chart of an exemplary embodiment of a present platform process to (i) verify the identity of a user (in this instance, an owner); (ii) verify the user's ownership nexus to a particular unlisted real property; (iii) allow the owner to confidentially register the unlisted real property to which he or she has a verified ownership nexus; and (iv) allow the owner to create or update a confidential property profile with respect to the registered unlisted real property.

FIG. 2b is a flow chart of an exemplary embodiment of a present platform process to (i) automatically notify the owner of a registered unlisted real property if and when the owner's property has been added to a potential purchaser's confidential list; (ii) allow the owner to review any confidential buyer profile and corresponding buyer profile completeness score associated with the potential purchaser; and (iii) allow the owner to initiate anonymous contact with the potential purchaser via the present platform's internal e-mail system.

FIG. 3 illustrates a system architecture showing the flow of data between third-party services and the present platform's client applications, according to one embodiment.

FIG. 4 illustrates a server architecture of the present platform, according to one embodiment.

### DETAILED DESCRIPTION

An exchange platform comprised of systems and processes for anonymously and confidentially introducing one or more potential purchasers of an unlisted real property to the owner of that property are disclosed. A computer-implemented method comprises (i) receiving identification data with respect to one or more unlisted real properties of interest from a potential purchaser of those properties via a client application; (ii) creating a confidential list for the potential purchaser consisting of all or a selected subset of the unlisted real properties for which property identification data was received from the potential purchaser; (iii) receiving property registrations from owners of unlisted real properties via a client application; and (iv) matching property identification data from property registrations against property identification data from the confidential list (and the confidential lists of other potential purchasers). If and when a match occurs, a matching notification is generated and the matching notification is transmitted to the owner of the matched property. A matching notification informs the owner of a potential purchaser's interest in purchasing the owner's property. At the owner's discretion, anonymous e-mail communication is then enabled between the owner and the potential purchaser.

Many unlisted real properties (each referred to below, unless otherwise noted, as a “property”) are actually purchasable even though their respective owners (or persons representing to possess the rights of ownership) (each referred to below, unless otherwise noted, as an “owner”) either have yet to make the decision to sell or are reluctant to publicly declare and disclose their intention to sell. Some owners are simply waiting for an external catalyst to crystalize their respective decisions to sell. Whereas more privacy-conscious owners, despite their respective intentions to sell, might hesitate to list their respective properties in order to avoid the exposure and inconvenience associated with public listings and showings.

The present platform disclosed herein facilitates anonymous and confidential introductions of potential purchasers of properties of interest (each referred to below, unless otherwise noted, as a “buyer”) to the owners of those properties. The present platform accomplishes this by (i) allowing owners to register their respective properties, which remain unlisted; (ii) allowing buyers to create one or more confidential list(s) of properties (each referred to below, unless otherwise noted, as a “buyer list”); (iii) automatically notifying the owner of a registered property when the owner's property has been included on one or more buyer list(s); and (iv) allowing the owner to decide whether to initiate anonymous communication, and possibly transaction negotiations, with one or more of the buyers who have included the owner's property on their respective buyer lists.

By allowing buyers to express their respective interests in particular properties and providing notification of those interests to the owners of those properties, the present platform provides fence-sitting owners with the requisite catalyst, or in the case of privacy-conscious owners, sufficient privacy, to convince and induce them to sell their respective properties to one of the buyers introduced by the present platform; in either case, without employing a broker, publicly listing their respective properties, or undertaking any FSBO marketing. The present platform provides (i) a buyer with an opportunity to purchase a property he or she truly wants even if that property is not listed for sale; and (ii) an owner with an opportunity to sell his or her property without paying a brokerage commission to a real estate intermediary and without exposing his or her property, and his or her willingness to sell, to the general public.

The processes and services described herein facilitate the present platform by allowing buyers to create one or more buyer list(s) using a combination of client-server technology; such as for example, server side services in conjunction with a Global Positioning System (“GPS”) enabled mobile device and image data optionality. A backend database, in conjunction with one or more matching process(es) (described below), is utilized to (i) match properties selected for inclusion by a buyer on one of his or her buyer list(s) with properties registered previously on the present platform by their owners and (ii) generate and automatically transmit notifications of any matches to the owners of the matching properties. This matching and notification process occurs each time a buyer adds a registered property to one of his or her buyer list(s). Once notified, an owner may decide to pursue a particular buyer's interest and initiate contact with the buyer by sending an internal e-mail via the present platform. All e-mail communications between owners and buyers on the present platform remain anonymous and confidential until such time as both parties mutually agree to reveal their identities.

The present platform is comprised of four principal components (although additional components are envisioned and described in further detail below): a client native mobile application (such as iOS), a client web application (such as Responsive Web), a server infrastructure, and an administration portal. A client native mobile application and a client web application may have similar user functionality, and are interchangeably referred to below as a “client application.”

A client application may allow a buyer to create a user account, access his or her user account, capture properties of interest, verify his or her identity, create one or more buyer list(s), and respond to messages received through the present platform.

A client application may also allow a buyer to create a confidential buyer profile (each referred to below as a “buyer profile”) which may include any supporting documentation which that buyer believes may add to his or her credibility as a potential purchaser, thereby providing owners with an inducement to initiate contact with that buyer via the present platform, and engage him or her in transaction negotiations.

A client application may allow an owner to create a user account, access his or her user account, verify his or her identity, verify his or her ownership nexus to a particular property, register the property to which his or her ownership nexus has been verified, receive a notification from the present platform each time a buyer includes the owner's property on one of his or her buyer list(s), and send and receive messages through the present platform.

A client application may also allow an owner to create a confidential profile for each property he or she registers (each referred to below as a property profile). A property profile may describe the main characteristics of the property (including photographs, traditional video and 360 video). The property profile may be shared with buyers on whose buyer list(s) the property has been included, at the discretion of the owner.

Multiple third-party services interface with the present platform, including services that facilitate identity verification, property ownership verification, payment processing, e-mail, notifications, deep linking, listing recognition, performance monitoring and analytics. These services may be local or external to the server. These services may also be interfaced directly with client devices and their respective client applications.

The devices on which the present platform operates may be grouped into three principal categories: client side devices, server side devices, and administrative devices. Client side devices may be comprised of mobile electronic devices (such as laptops, smartphones, tablets, GPS receivers, or the like) and desktop devices or the like; whereas server side devices may be physical or virtual servers servicing the client side devices. Administrative devices may be client side devices or server side devices depending on the physical or virtual arrangement.

While the embodiments disclosed herein relate to real property, and specifically residential real property, the systems and methods described herein may be equally applicable to other categories of real and personal property. For example, commercial real estate, industrial real estate, and agricultural real estate with respect to real property; and yachts, private aircraft, rare wine, collectible automobiles and fine art, for example, with respect to personal property. In fact, the systems and methods described herein could be applied to any type of high-value personal property that is (i) either unique or rare and (ii) known and recognizable to potential purchasers of that personal property. To minimize complexity for users, a unique user interface may be established for each category of real or personal property to which the present platform systems and methods are applied.

With respect to unique personal property—for example, a painting by Picasso or a custom yacht (fine art and yachts being two categories of personal property that are notoriously purchasable at any time, for the right price)—a potential purchaser would identify that personal property by name on his or her confidential personal property list on the appropriate category-specific user interface (e.g., Fine Art). A match would occur if and when the owner of that personal property registered that personal property on the appropriate category-specific user interface (e.g., Fine Art).

Alternatively, with respect to rare personal property—for example, 1962 Shelby Cobra automobiles or Gulfstream G500 airplanes—a potential purchaser would identify that personal property by object designator, vintage year or other defining characteristics common to the genre on his or her confidential personal property list on the appropriate category-specific user interface (e.g., Collectible Automobiles). A match would occur if and when an owner of one of the rare examples of that personal property registered that personal property on the appropriate category-specific user interface (e.g., Collectible Automobiles). Accordingly, a potential purchaser of a rare example of personal property might receive multiple matches (each to a unique owner) in respect of a single inclusion on his or her confidential personal property list. (The residential real property analogy to rare personal property is multiple units in a multi-unit residential property—a cooperative or condominium—in which case (as described below), a buyer has the option of including on his or her buyer list all units comprising that multi-unit property, as opposed to a single specific unit.)

### User Accounts:

In one embodiment, every user interested in participating on the present platform, as an owner or as a buyer, may create a unique present platform user account via a client application in conjunction with one or more central server(s) and third-party services.

An exemplary embodiment of a process to create user accounts includes robust identity verification, performed on the server(s)—identical for both owners and buyers—thereby ensuring that both owners and buyers are in fact unique individuals who are who they claim to be, and not bad actors intent upon deceiving other users. A user, by way of a client application, provides the present platform with his or her identity information during the initial login/sign-up process. The present platform then compares the information provided by the user with information obtained from third-party providers. Should the quality or quantity of identity information provided by a user be in question, the user would be denied a user account or required to provide additional information in order to complete the identity verification process. If the information is sufficient and the user's identity is verified, an identity verified user account is created for the user. Users without identity verified user accounts may not participate on the present platform, or may have limited access to the functionality of the client applications. For example, a buyer may open a user account and capture properties prior to completing the requisite identity verification steps, but may not be able to create a buyer list, create a buyer profile or transfer captured properties from the cache to a buyer list until such time as his or her identity has been verified.

Once his or her identity has been verified, a buyer may create one or more buyer list(s) (as described below) comprised of some or all of the properties previously captured by the buyer. Alternatively, a buyer may elect to include a property directly on one of his or her buyer list(s) without capturing it first in a cache.

A buyer may also have the opportunity, at his or her discretion, to create a buyer profile. A buyer profile may contain a description of the buyer's occupation, current residential situation, affiliations, closing conditions he or she would be willing to waive, mortgage pre-approvals, etc. The present platform may generate questions and/or suggestions to help a buyer complete his or her buyer profile. Additionally, a buyer may elect to upload and append any documents (redacted credit reports, mortgage pre-approvals, resumes, personal references, links to social media pages, etc.) which the buyer believes may support his or her credibility as a potential purchaser. A relatively complete buyer profile may induce owners to contact the buyer and initiate the negotiation process through the present platform. The present platform may generate a buyer profile completeness score on the basis of the data supplied by the buyer in his or her buyer profile. An algorithm reviews the buyer's submissions to determine which sections of the buyer's buyer profile contain information versus which sections were left blank. The buyer profile completeness score quantifies the amount of information provided by the buyer on his or her buyer profile. The present platform may share the buyer completeness score (as well as the buyer profile from which it was derived) with owners of properties included on the buyer's list(s). However, the present platform does not disclose the identity of the buyer to the owners.

### Property Registration:

Once his or her identity has been verified, and an identity verified user account has been established, an owner may proceed to register a property. An owner may register, for example, a single-family home, a parcel of undeveloped, residentially-zoned land, a single unit of a multi-family dwelling or, in the case of a developer, an entire multi-family development. The property registration routine includes a robust property ownership verification process that ensures that the party registering a property as an owner has a verifiable nexus to the ownership of the property. In one embodiment, if an owner receives postal mail at the address of the property he or she is attempting to register, the owner may opt to verify his ownership nexus to the property by having the present platform mail a postcard to the owner at the property address. The postcard contains a key code that the owner, in turn, enters into his or her client application to complete the ownership verification process. Alternatively, if the owner does not receive mail at the address of the property he or she is attempting to register, he or she has the option of uploading either (i) a property tax bill for the property or (ii) a deed to the property. In the event that the name on the tax bill or deed is different from the name of the owner, the owner would be asked to describe his or her relationship to the name on the deed or tax bill (e.g. Trustee, Executor, Managing Member, General Partner, etc.). Any uploaded documents and any associated relationship description would be reviewed (internally or by a third-party) for accuracy (address match) and authenticity (validity). If the uploaded documentation passes review, the ownership verification process would be deemed complete. Alternatively, if the property documents uploaded by a user conflict with information previously provided to the present platform (e.g. a user claims ownership of a property that was registered previously by a different user), the present platform would initiate further review and may request additional documentation.

Once ownership has been verified, an owner may also have the opportunity, at his or her discretion, to create a property profile for the property he or she successfully registered. A property profile may describe the main characteristics of a registered property and could include any descriptive information that an owner thinks might be of interest to a buyer, including information that may not be available to the general public. Additionally, the present platform encourages owners to upload photographs, traditional videos and 360 videos of their respective properties' distinguishing characteristics. Property profiles remain confidential unless and until an owner, at his sole discretion, chooses to provide access to a buyer who has included the owner's property on one of his or her buyer's list(s).

Upon receiving a matching notification from the present platform informing an owner that his or her property has been added to a buyer list, the owner might rely upon the buyer profile, if any, or the corresponding buyer profile completeness score, to assess the credibility of the associated buyer as a potential purchaser and to determine whether to initiate contact with the buyer through the present platform. Communication between the owner and the buyer remains anonymous and confidential until the time as both parties mutually agree to reveal their identities.

Once an owner has established communication through the present platform with a buyer who has included the owner's property on one of his or her buyer list(s), the owner may decide to provide access to the property profile for his or her property by means of, for example, a digital key or password. Buyer access to a property profile may be limited with respect to the length of time it is available for viewing. A property profile, or a buyer's access thereto, may be removed at the discretion of the property's owner. Property profiles created on the present platform, which, except as stated above, remain confidential at all times, are neither posted nor searchable on the present platform. Furthermore, properties registered on the present platform cannot be advertised nor listed on the present platform. As a result, an owner is not required to provide any information beyond what is necessary to create his or her user account and verify his or her ownership nexus (as described above) to a particular property.

### Property Capture:

Property capture is an interim process performed by a buyer whereby the buyer provides data to the present platform with respect to a property of interest. A property's data including, but not limited to, the street address of the property, may be provided to the present platform via a client application, either manually or by using a GPS-enabled mobile device, which in turn may communicate with the client application. The client application, in the latter case, may receive geographic coordinates provided by the GPS functionality of the GPS-enabled mobile device. Additional data regarding a captured property including, but not limited to, digital images and/or notes generated by the buyer, may be attached to the record. Any data relating to a captured property may be generated and/or supplied to the present platform through a mobile device (and respective native client application) or directly through the client web application. For example, a buyer may capture a property address using a GPS-enabled mobile device, but not supply notes regarding the property until a later date from, for example, a desktop computer or a tablet using a client web application.

A client application may relay the captured property data to a server used by the present platform. The captured property data is then saved by the server in a pending state, such as in a cache, for later review and possible inclusion on a buyer list. An identity verified buyer then has the option of moving a property he or she captured previously from the cache to one of his or her buyer list(s) or leaving or deleting the property from the cache as desired. The present platform may place limits on the number of properties that can be captured by a buyer, the duration a property may remain in the cache or the amount of memory a buyer may utilize for captured properties. In addition to buyer generated notes with respect to a captured property, buyers may also have the option to identify the distinguishing characteristics of captured properties using, for example, structured data drop-down lists. Examples of distinguishing characteristics might include architecture, landscaping, proximity to schools and amenities, topography, etc.

### Buyer Lists:

Buyers may create one or more buyer list(s) of properties which they would be interested in pursuing if the owners of the properties were to consider selling. Buyers may add properties to their buyer lists from (i) those properties the owners captured previously and stored in the cache or (ii) directly—skipping the capture process entirely—to the extent a buyer is definitive with respect to his or her interest in the property. When a buyer includes a property that is a single unit of a multi-unit property on one of his or her buyer list(s), the buyer has the option of including just that unit or every unit of the multi-unit property on the buyer list. A buyer may add or delete properties to or from one of his or her buyer list(s) or move properties from one of his or her buyer list(s) to another of his or her buyer list(s) at his or her discretion. Buyer lists are proprietary to individual buyers and are not disclosed or shared on the present platform with others users, nor are they searchable. However, buyers may have the option, without limitation, to export to or share their buyer list(s) with third-parties. For example, a buyer may share his or her buyer list with his or her spouse, architect, interior designer, mortgage broker, etc.

The present platform preserves the confidentiality of buyers' and owners' respective identities. However, by adding a property to one of his or her buyer list(s), a buyer consents to the disclosure of his or her buyer profile to the owner of the property, and to be contacted anonymously by the owner through the present platform. This consent occurs without any further agreement (by default) on the part of the buyer.

The present platform may monitor and track all properties included on all buyer lists. If and when the present platform monitoring process detects that a property has been publicly listed on a third-party listing platform, such as, for example, an MLS, a real estate portal or other conventional real estate platform, the present platform may send notifications of the public listing of the property to each buyer who included the property on one of his or her buyer list(s).

### Matching Notifications and Other Communication:

To the extent that a property is registered on the present platform, inclusion of the property by a buyer on one of his or her buyer list(s) prompts the present platform to automatically transmit a matching notification of the buyer list inclusion to the owner of the property. To the extent that a property is not registered on the present platform, an external communication may be sent to the owner (once identified) of the property from the present platform (i) informing the owner that one or more buyer(s) on the present platform have expressed interest in the owner's property, (ii) encouraging the owner to visit and explore the present platform and (iii) inviting the owner to become a user and to register the owner's property on the present platform. The invitation may be sent via one or more forms of communication, including, without limitation, e-mail, postal mail or some other form of digital or physically-delivered correspondence.

The only information included in the matching notification that an owner receives through the present platform when a buyer has added the owner's property to one of his or her buyer list(s) is the fact that the owner's property has been included on the buyer list. No other properties included on the buyer list are disclosed to the owner. However, buyers may receive notifications from the present platform when owners review their respective buyer profiles. This may create an inducement for buyers to seek higher buyer profile completeness scores by populating their respective buyer profiles with more detailed and complete information.

An owner may receive multiple matching notifications with respect to the owner's property, as each new inclusion by a buyer of the owner's property on one of his or her buyer list(s) triggers a separate matching notification from the present platform to the owner. An owner who has received only one matching notification over a given time period might conclude that interest in his or her property was limited. Whereas, an owner who has received multiple matching notifications during that same time period (indicating inclusion of his or her property on multiple buyer lists) might conclude that interest in his or her property was relatively high.

Once an owner of a registered property has received a matching notification from the present platform informing the owner that a buyer has added the property to one of his or her buyer list(s), the owner may decide to review the buyer's buyer profile, if any, and the corresponding buyer profile completeness score. To the extent that the owner deems the buyer credible as a potential purchaser, the owner may elect to contact the buyer via the present platform's internal anonymous communication system and initiate transaction negotiations. The communication system may rely, without limitation, on e-mail or SMS messaging (texting).

### Analysis:

The present platform may monitor itself and provide various levels of analysis. For example, the present platform may maintain counts of the number of properties registered, the number of identity verified users, and the number of buyer lists created. The present platform may also perform analysis on the number of properties included in buyer lists, including the rate of inclusion, the geographic concentration of the properties and the percentage of properties initially captured in a cache or added directly to buyer lists. It may also be of interest to the present platform administrators to know the number of buyer lists on which a particular property is included. Owners may be provided with a counter showing the number of buyer lists on which their respective properties are included. As previously described, the monitoring process may monitor the pool of properties on buyer lists for any matches with public listings published by third-party services.

### System:

In one embodiment, the present platform includes a client application with which a buyer may capture properties and include them on one or more buyer list(s). The application may operate on a client electronic device via a client-server architecture, wherein a client side device may be a mobile electronic device (using a native client application such as a native mobile application), a desktop (using a native desktop application or web client), a thin client (for instance, an application that runs within a web browser), or other device capable of executing code sufficient to support the process. Using, for example, a mobile application on a mobile device (such as a smart phone or tablet), a buyer may capture a property and include the property on a buyer list while on the go. A client application in conjunction with a client electronic device communicates with a server to store property data and the buyer list in a storage location, such as a drive. The server may be a physical stand-alone device or a virtual server in a multi-server environment. The client and server communicate over known communication means, such as by wireless connection or via a wired connection, to relay information between them. Communication of data, such as personally identifiable information, may be encrypted before transmission using one of various encryption methodologies, known in the encryption art. The system may allow for user account administration as generally known in the information technology field, such as, but not limited to password reset, suspension and deletion of user accounts.

A client native mobile application, such as might be used in a smart phone or tablet, for example, may facilitate property capture by use of the device's other interfaces, components and functionality. GPS, camera, Wi-Fi, accelerometer, Bluetooth™ or any other functionality built into a buyer's mobile device may be used to capture property data. The application may associate the GPS data and image data with other property data as described above, such as a street address. The client native mobile application may collect information from, and facilitate transmission of data to, centralized server(s) where it can be associated with other property data, such as the property address and property ownership.

Mobile electronic devices may encompass phones, smart phones, tablet computers, smart cameras, or any mobile electronic device with similar capabilities to identify a location. A mobile electronic device in concert with a client native mobile application may associate GPS data with one or more images of a property and other data available regarding the property, such as that disclosed above. The mobile electronic device may comprise some or all of the components to capture GPS and/or image data. Alternatively, components may be separated into one or more distinct device(s) and connected by wires or wireless communications. The client native mobile application may be stored and operated within one or more of the distinct device(s) described above, or in a separate device. One such mobile electronic device may be a vehicle, such as an automobile or drone. The vehicle may include a GPS, a camera, an accelerometer, the client native mobile application or any combination thereof.

Embodiments of the invention are illustrated in the accompanying drawings. The sequences identified in the exemplary diagrams and described herein may be performed in alternative orders to those shown and/or performed via various combinations. Determination steps may be performed in a looping process or one associated with a class in an object oriented programming methodology.

Portions of the process may be performed by a client in a client/server arrangement, for example such as a client native mobile application on a mobile electronic device. Other portions may be performed by a server, which may comprise one or more server(s), in a centralized or distributed server topology. Other arrangements, as previously described, may be used.

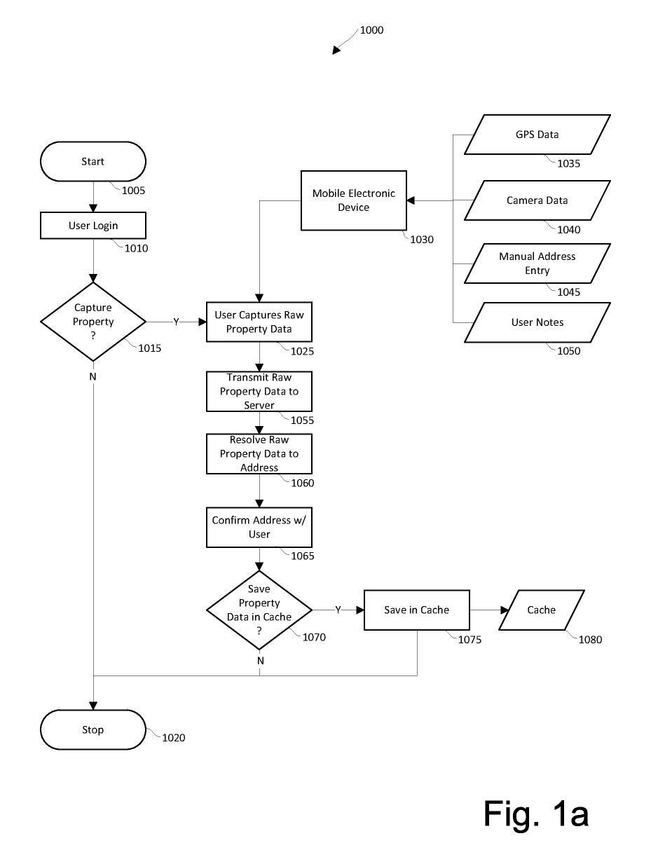

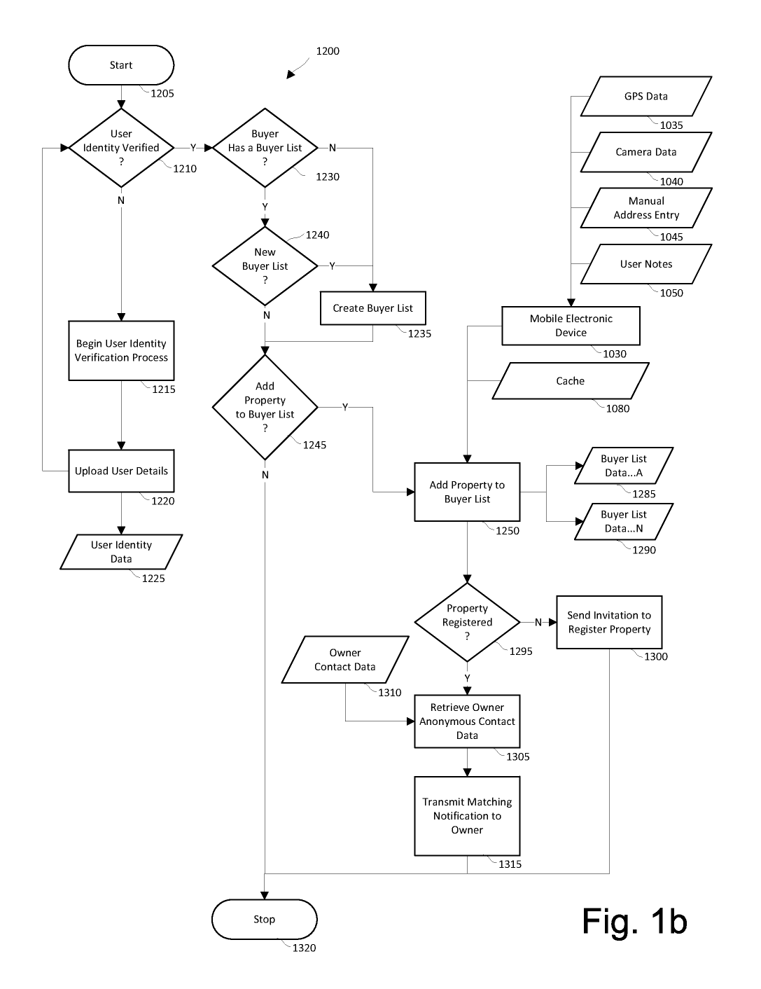

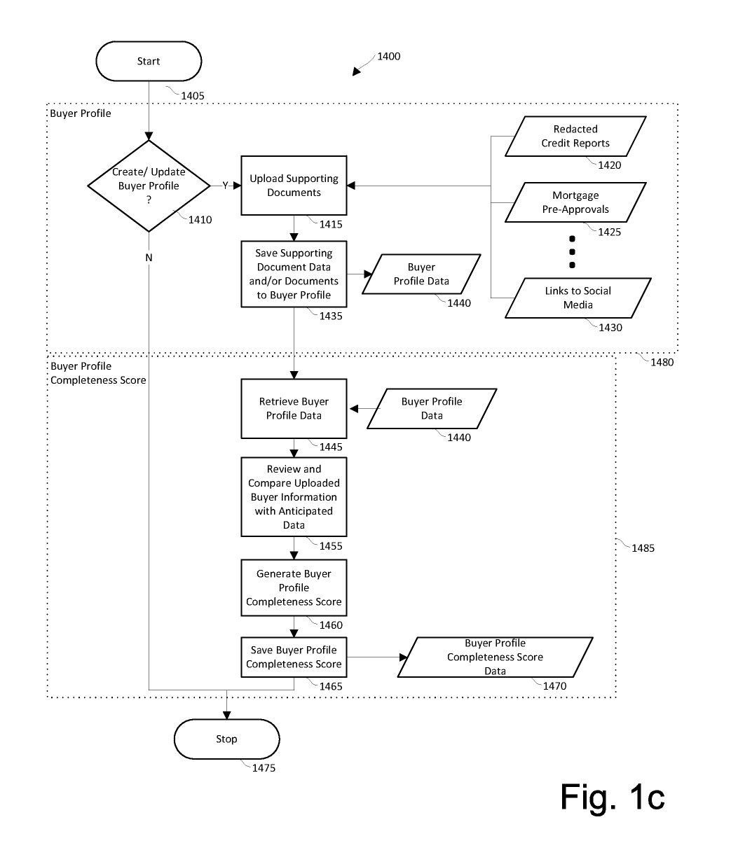

Turning to FIG. 1a, flow chart 1000 illustrates an exemplary embodiment of a present platform process to (i) allow buyers to capture property data (such as street addresses, notes, and photographs) and (ii) cache the data in a pending state. The process is initialized at step 1005, after which a user logs in to the present platform at step 1010. If the determination at step 1015 is negative (the user indicates that he or she does not want to capture a property), process 1000 ends at step 1020. Alternatively, an affirmative determination at step 1015 (the user indicates that he or she wants to capture a property), results in the capture of raw property data process at step 1025 via, in this example, a client native mobile application on an accessible mobile electronic device 1030. The client native mobile application captures resources from the mobile electronic device 1030, such as GPS data 1035 from a GPS device within the mobile electronic device 1030, camera data 1040 from a camera device within the mobile electronic device 1030, address data 1045 entered manually by the user on the mobile electronic device 1030, user notes 1050 entered manually by the user on the mobile electronic device 1030, or any combination of the above. (The camera associated with the mobile electronic device might be used to photograph the distinguishing characteristics of the property in order to aid the user in recalling the property at a later time. Similarly, user notes may be used to describe the property details or distinguishing characteristics for the benefit of the user.)

Once the raw property data has been captured at step 1025, the client native mobile application, in this example, communicates the raw property data to the server(s) at step 1055 in order for the server(s) to resolve the raw GPS data into probable addresses at step 1060. The server(s), having resolved the raw property data into probable addresses, return a list of surrounding street addresses to the client native mobile application at step 1065 in order to confirm the address with the user. Presentation of the proposed addresses by the client native mobile application may be, for example, in the form of a drop down list. After the user confirms the address, a determination is made with respect to saving the property data at step 1070. (Alternatively, the user has the option to manually enter the property address at step 1045. In the event that the user manually enters the property address, the process bypasses step 1060 and step 1065 and proceeds directly to step 1070.) If the determination at step 1070 is negative (the user indicates that he or she does not want to save the property), process 1000 ends at step 1020. Alternatively, an affirmative determination at step 1070 (the user indicates that he or she wants to save the property) results in the property data being saved at step 1075 in a cache storage location 1080; after which process 1000 ends at step 1020.

Turning to FIG. 1b, flow chart 1200 illustrates an exemplary embodiment of a present platform process to (i) verify the identity of a user (in this instance a buyer); (ii) allow the buyer to create one or more buyer list(s); (iii) allow the buyer to populate his or her buyer list(s) with those captured properties that the buyer has decided to pursue; (iv) automatically notify the owner of a registered property if and when his or her property has been added to one or more of the buyer list(s); and (v) invite the owner of an unregistered property that has been added to one or more of the buyer list(s) to visit the present platform and register the property. The process initiates at step 1205, after which the user logs in to the system at step 1010. A determination is made at step 1210 as to whether the user's identity has been verified previously. If the user's identity verification determination result is negative, the identity verification process initiates at step 1215. This, in turn, requires the user to upload user details via a client application at step 1220, which the server(s), in conjunction with third-party services (described below), either accept or reject. The uploaded user identity data is then stored in a storage location on the server(s) at step 1225. The process then loops back to repeat the determination for the verification process at step 1210. With an affirmative determination that the user's identity is verified at step 1210, a further determination of an extant buyer list for the user is performed at step 1230. If the user, now verified and acting as a buyer, has no buyer list(s), a buyer list is created at step 1235. Alternatively, if a buyer list is determined to exist for the buyer at step 1230, a further determination is made in response to the buyer's indication to create an additional buyer list at step 1240. With a positive determination at step 1240 (the buyer indicates a desire to create an additional buyer list), the process creates a new buyer list at step 1235. After completing the buyer list creation process at step 1235, or a negative determination at step 1240 that an additional buyer list is not to be created, a determination is made at step 1245 whether the buyer indicates a desire to add a property to one of the buyer's buyer list(s). When a negative determination is made at step 1245 (the buyer indicates that he or she does not desire to add a property to a buyer list), process 1200 ends at step 1320. Alternatively, an affirmative determination at step 1245 results in adding a property to a buyer list at step 1250. The property to be added may be selected from the previously captured properties stored in the Cache 1080 or by capturing a new property (as depicted in FIG. 1a) by drawing on raw property data from one or more resources, such as the mobile electronic device 1030 with associated GPS data 1035, camera data 1040, manually entered address data 1045, or user notes 1050.

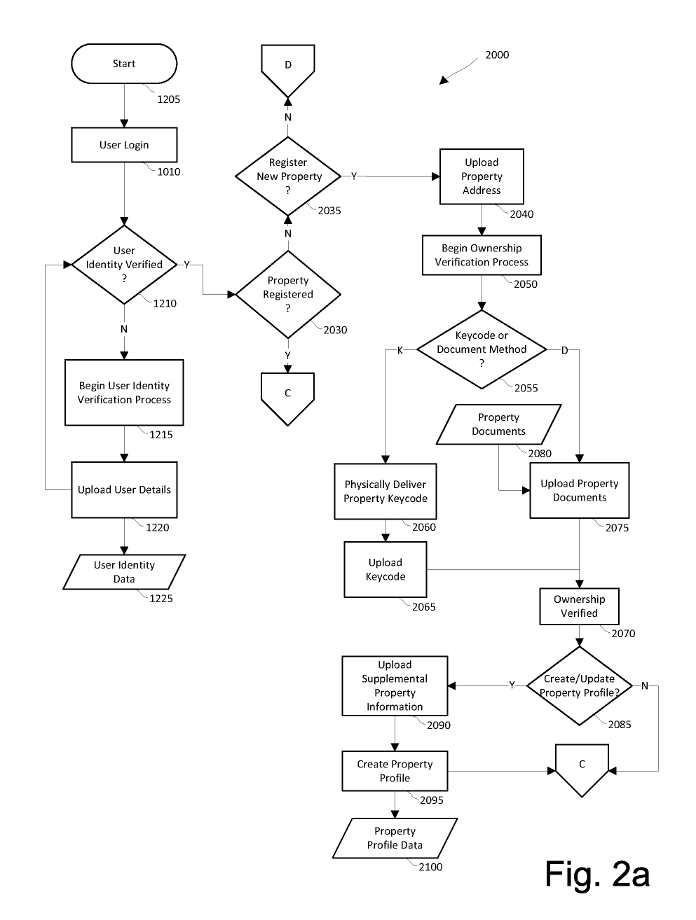

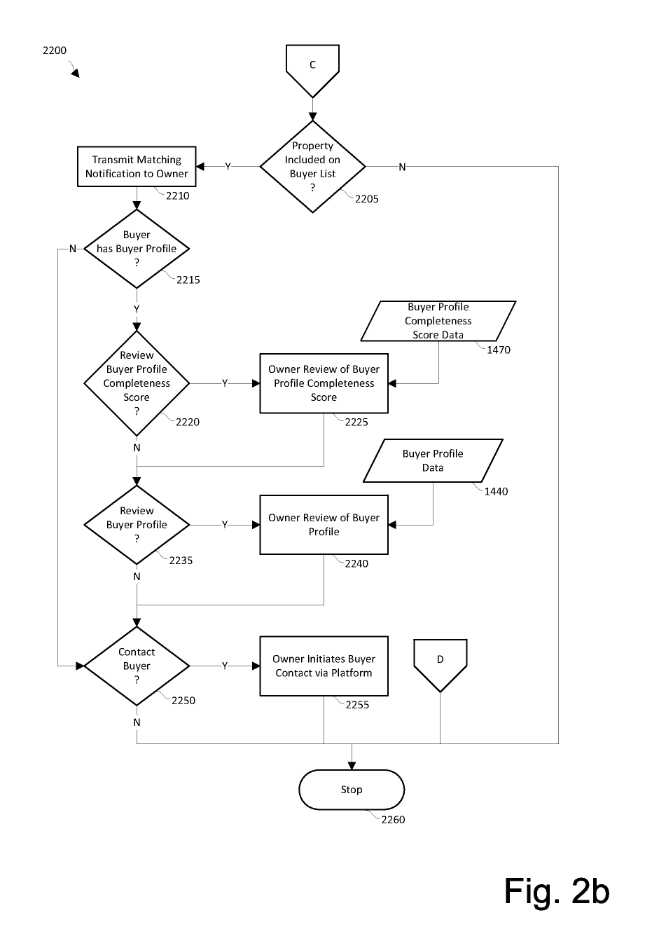

The buyer's captured property data from step 1250 is stored in one of multiple possible buyer list(s) 1285 through 1290 which may be saved in one or more storage locations on the server(s). The process then proceeds to step 1295 at which a determination is made as to whether the property newly added to the buyer list is registered on the present platform. If the determination at step 1295 is negative, an invitation to register the property is sent to the property's owner (once identified) at step 1300. Upon completing the invitation process at step 1300, process 1200 ends at step 1320. However, if the determination at step 1295 is positive (i.e. the property is registered on the present platform as depicted in FIG. 2a) the process proceeds to step 1305 where the owner's anonymous contact data is retrieved from the owner contact data storage location 1310 on the server(s). The owner contact data 1310 is derived from the user identity data 1225 stored during the user identity verification process for the owner. (The user identity verification process for an owner is identical to the user identity verification process for a buyer. See FIG. 2a.) Owner contact data is used at step 1315 to automatically transmit a matching notification, informing the owner that the buyer has included the owner's registered property on his or her buyer list. After which, process 1200 ends at step 1320.

Turning to FIG. 1c, flow chart 1400 illustrates an exemplary embodiment of (i) a present platform process 1480 to create or update a buyer profile comprised of supporting documents and other information uploaded by a buyer and (ii) a present platform process 1485 to automatically generate or update a metric that scores the completeness of that buyer profile. The process is initialized at step 1405, after which a determination is made whether to create or update a buyer profile based on an indication from the buyer at step 1410. If the determination at step 1410 is negative, process 1400 stops at step 1475. Otherwise, the buyer uploads one or more supporting document(s) at step 1415. Supporting documents, such as redacted credit reports 1420, mortgage pre-approvals 1425, and links to social media 1430 may be uploaded to the server(s) to support buyer entries to the buyer profile. Once the buyer has input buyer profile data (which may take the form of answers to a present platform-generated questionnaire) and/or uploaded one or more supporting document(s), the process saves the buyer input and the supporting documents at step 1435 and stores the data and documents to the buyer profile data storage location 1440 on the server(s) for later use. (A buyer may update his or her buyer profile at any time, at his or her discretion.)

Upon completion of the buyer profile creation or update process 1480, the server(s) automatically generate or update the buyer profile completeness score via process 1485. The process begins at step 1445 to retrieve the previously saved buyer profile data 1440. After which a review and comparison of the uploaded buyer data with anticipated data is performed at step 1455. In response to the review and comparison process at step 1455, the process at step 1460 generates or updates the buyer completeness score by comparing the uploaded documents and other buyer inputs with a fully completed template of a buyer profile. The buyer profile completeness score is then saved at step 1465 and stored in a buyer profile completeness score data storage location 1470 on the server(s). Once the buyer profile completeness score is stored, process 1485 ends at step 1475.

FIG. 2a (flow chart 2000) and FIG. 2b (flow chart 2200) comprise overlapping processes. Flow chart 2000 illustrates an exemplary embodiment of a present platform process to (i) verify the identity of a user (in this instance an owner); (ii) verify the user's ownership nexus to a particular property; (iii) allow the owner to confidentially register the property to which he or she has a verified ownership nexus; and (iv) allow the owner to create or update a property profile with respect to the registered property. Flow chart 2200 illustrates an exemplary embodiment of a present platform process to (i) automatically notify the owner of a registered property if and when the owner's property has been added to a buyer list; (ii) allow the owner to review any buyer profile and corresponding buyer profile completeness score associated with the buyer; and (iii) allow the owner to initiate anonymous contact with the buyer via the present platform's internal e-mail system.

Turning to FIG. 2a, the process initiates at step 1205, after which a user logs in to the present platform at step 1010. A determination is made at step 1210 as to whether the user's identity has been verified previously. If the user's identity verification determination result is negative, the identity verification process initiates at step 1215. This in turn requires the user to upload user details, via a client application at step 1220, which the server(s), in conjunction with third-party services (described below), either accept or reject. The uploaded user identity data is then stored in a storage location on the server(s) at step 1225. The process then loops back to repeat the determination for the verification process at step 1210. With an affirmative determination at step 1210 that the user's identity has been verified, a further determination is made by the server(s) at step 2030 with respect to whether the identity-verified user has previously registered a property. If the determination at step 2030 is negative, a further determination is made at step 2035 as to whether the user indicates a desire to register a previously unregistered property. Steps that follow a negative determination at step 2035 [D], or an affirmative determination at step 2030 [C] are depicted on flow chart 2200 of FIG. 2b.

An affirmative determination at step 2035 (to register a previously unregistered property) causes the present platform to prompt the user for property address data to be uploaded at step 2040. Once the owner uploads the property's address at step 2040 the ownership verification process is triggered at step 2050. Ownership verification may be achieved using one of two methods. The method to be applied in respect of a particular property is determined by the purported owner's indication at step 2055. The first method is to physically deliver (via postal mail or private delivery) a unique key code at step 2060 to the street address of the property a purported owner is attempting to register. (A key code is an arbitrary and unique alphanumeric code that the present platform associates with a unique property address.) Upon receipt of the key code, the purported owner uploads the key code via a client application at step 2065 to the servers(s). If the uploaded key code matches the key code that was delivered to the property's address, ownership is deemed verified at step 2070 by the server(s). The second method (for a purported owner who does not receive mail at the address of the property he or she is attempting to register) is for the purported owner to upload property specific documents (such as an property tax bill or the property's deed) 2080 at step 2075 to establish that the purported owner has the authority and power of an owner for purposes of registering the property on the present platform. Uploaded property documents 2080 are reviewed by a present platform administrator (or a third-party service) to verify accuracy and validity. Once approved, the reviewer instructs the server(s) that ownership has been verified at step 2070.

Once ownership of a property has been verified at step 2070, the owner of the property is provided an opportunity to create a property profile at step 2085. An affirmative determination at step 2085 results in instructions (not shown) for the owner to upload any supplemental property information via a client application at step 2090 to the server(s). (The creation of a property profile may be assisted by a platform-generated questionnaire. Additionally, the present platform encourages owners to upload photographs, conventional videos, and 360 videos of the property's distinguishing characteristics.) Thereafter, the process creates a property profile at step 2095 and stores the property profile data 2100 at a storage location associated with the server(s). A negative determination at step 2085 indicates the owner's desire not to create a property profile and results in a bypass of the property profile process. Following (i) the completion of the property profile process at step 2095, (ii) a determination to bypass of the property profile process at step 2085, or (iii) an affirmative determination at step 2030 that the owner has already registered a property, the process proceeds to a determination at step 2205 (as shown on flow chart 2200 of FIG. 2b) as to whether the registered property is already included on one or more buyer list(s).

Turning to FIG. 2b, if a negative determination is made at step 2205, process 2000 ends at step 2260. Alternatively, an affirmative determination at step 2205 results in the process automatically generating and transmitting a matching notification to the property's owner at step 2210. (Although flow chart 2200 depicts a single matching notification transmission, multiple matching notifications may be generated and transmitted if the newly registered property is included on multiple buyer lists. Additionally, once a property has been registered, the present platform automatically generates and transmits additional matching notifications to the property's owner every time the property is added to a buyer list.)

Following the matching notification transmission(s) at step 2210, a determination is made at step 2215 as to the existence of a buyer profile for the buyer who included the property on one of his or her buyer list(s). If the determination at step 2215 is negative, the process proceeds to step 2250 where a determination is made as to whether the owner indicates a desire to contact the buyer (described in more detail below). However, if the determination at step 2215 is affirmative, a further determination is made at step 2220 as to whether the owner indicates a desire to review the buyer profile completeness score for the buyer. If the determination at step 2220 is affirmative, the process presents the owner with the buyer profile completeness score at step 2225 from the stored buyer profile completeness score data 1470, and subsequently proceeds to the determination at step 2235 as to whether the owner indicates a desire to review the actual buyer profile for the buyer. In order for the owner to review either the buyer profile completeness score and/or the buyer profile, the server(s) transmit the relevant data to the client application.

If the determination at step 2220 is negative, the buyer profile completeness score review process is bypassed and the owner proceeds to the determination at step 2235 as to whether the owner indicates a desire to review the buyer's buyer profile. An affirmative determination at step 2235 causes the process to present the buyer profile data 1440 to the owner at step 2240 via the client application and to subsequently proceed to the determination at step 2250 as to whether the owner indicates a desire to initiate contact with the buyer via the present platform. If the determination at step 2235 is negative, the buyer profile review process is bypassed and the owner proceeds directly to the determination at step 2250 as to whether the owner indicates a desire to initiate contact with the buyer via the present platform.

If the determination at step 2250 is negative, process 2200 ends at step 2260. However, if the determination at step 2250 is affirmative, the process provides the owner (via the client application) with access to an anonymous and confidential present platform-based e-mail system for contacting the buyer at step 2255.

Although the embodiments above depict the use of a single electronic device (such as a tablet or smartphone), an associated native client application and one or more server(s); a user may perform the actions depicted on different devices running different client applications, and arrive at the same result. For example, an owner may indicate a desire to register a property on a mobile device, upload property address data using a web based application running on a laptop computer, and enter a key code for ownership verification on a third device, such as a mobile electronic device different from the one on which he or she registered an property.

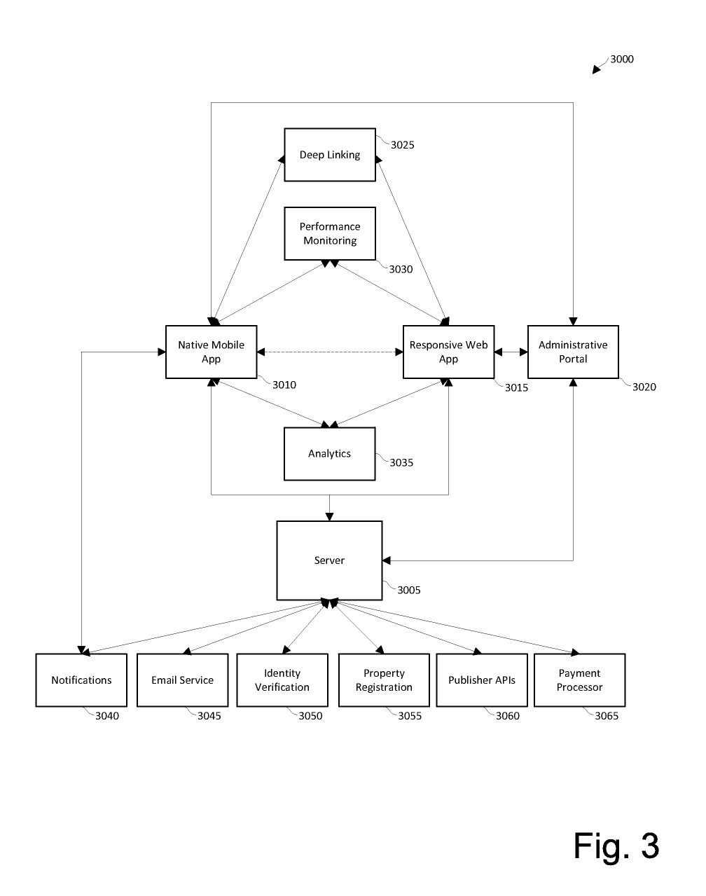

FIG. 3 illustrates an exemplary embodiment of a system architecture showing the flow of data between third-party services and the present platform's client applications. Data flows between (i) services and third-parties that facilitate identity verification, property registration, MLS data publishing, payment processing, digital notification and e-mail transmission, generation of physically-delivered correspondence, and present platform analytics and (ii) the server(s), are shown. Data at rest or in flow may be unencrypted or encrypted, such as with a 2048-bit SSL certificate. Main components of the present platform and other service components are also shown and may be modules, such as application programming interfaces (“APIs”) that interact with the server(s), client(s), or both. Services may be performed internally by the server, on another server, or externally by third-party service providers and transmitted between the server and the third-party service providers. A server 3005 sends and receives data from an Administrative Portal 3020 for system administrators to manage the present platform (for example, back-office services). Management functions may include periodic maintenance, upgrades, user manipulation and the like. The server 3005 also receives and sends data between itself and a native mobile app 3010 (e.g., mobile app) and a responsive web app 3015 (e.g., web app) to facilitate the fundamental operation of the present platform, namely (i) the identification of properties by buyers, (ii) the registration of properties by owners, (iii) the creation of buyer lists by buyers, and (iv) the facilitation of confidential communication between matching owners and buyers. The native mobile app 3010 and responsive web app 3015 may communicate between themselves, independently of the server 3005. The native mobile app 3010 and the responsive web 3015 also may be subject to performance monitoring 3030. The performance monitoring is performed on, and with respect to, the backend and frontend apps to find and quickly resolve bottlenecks, as well as mobile crash-reporting to help quickly diagnose issues. Data also flows between the native mobile app 3010 and Analytics 3035, as well as the responsive web app 3015 and analytics 3035 to track user engagement, retention and conversion. In addition to tracking baseline analytics, custom events and key performance indicators (KPIs) can be established to further analytics depth.

The server 3005, in communication with notification service 3040, may send and receive communications, such as instructions, for the notification service 3040 to notify the native mobile app 3010 of information. This is shown and supported by the data flow between these components. Notifications 3040 may be used to deliver information related to property listing status, buyer list matches, etc. to users. This information flows from the server 3005 to the notification service 3040 to the native mobile app 3010, with confirmations returning in reverse chronological order.

E-mail service 3045 aids in the delivery of bulk and individual e-mails. Engagement with e-mails by the recipients can also be monitored by the administrator(s) of the present platform by the reverse flow of this data back to the server 3005. E-mail can be used to facilitate communications between an owner and buyers and also for administration and marketing purpose. When an owner initiates communication with a buyer, the communication is, as previously described, anonymous. The owner may select a link, without knowledge of the buyer's identity, to initiate the e-mail communication process. Once contact is established between an owner and a buyer, multiple e-mail communications may be exchanged between the parties. The server 3005, having received instructions, might formulate a communication independent of the initiator and transmit the formulated communication to the e-mail service 3045 to carry out transmission, such as when a property on a buyer list becomes listed on a third-party platform. Alternatively, the server 3005 may instruct the e-mail service 3045 to formulate the communication based on data transmitted from the server 3005, as well as transmit the e-mail. Responsive e-mail communications may also be received by the e-mail service 3045 component and relayed for receipt by the server 3005 for further operation. Operations may include analytics on the e-mail and routing of an anonymous communication back to the initiator. E-mail communications remain anonymous until parties wish to introduce themselves.

Data flow between the identity verification service 3050 and the server 3005 is also shown. Information from the user, via one of the client applications described above, flows from the application to the server 3005 and on to the identity verification 3050 service. User identity verification on the present platform may be a two-step process. The first step may be a high level verification of a user's e-mail address and/or phone number against a third-party service to ensure the person is human and not a machine, such as a bot (an automated or semi-automated robotic tool that carries out repetitive and mundane tasks). After this verification is complete the user is able to login to the client application. However, before a user can create buyer lists, or before a user can register a property he or she may be required to complete a second level of identity verification called Knowledge Based Authentication (KBA). This presents a series of questions, the answers to which only the user would know.

Property registration (and the associated ownership nexus verification) 3055 service, and the data flow between it and the server 3005 is distinct from, and in addition to the user identity verification 3050 process described above. Property registration 3055 may be facilitated using a combination of services that offer ownership nexus verification alternatives to the owner. The services may include physical delivery of correspondence containing a key code, and uploading of property documentation. Information from the owner via one of the client applications described herein flows to the server 3005 and on to the property registration 3055 service. Additionally, when a buyer includes a property on one of his or her buyer list(s) that had not been registered previously on the present platform, the present platform attempts to identify the owner of the unregistered property and send a communication with an invitation including a unique code that can be used to complete the property registration 3055 process. An API may be used for sending notifications, including, but not limited to, e-mails or physical delivery correspondence to property owners who had not previously registered their properties on the present platform.

Data flow between the server 3005 and one or more publishing APIs 3060 allows the present platform to search for and identify listing data with respect to specific properties. When a buyer adds a property to a buyer list, the backend uses one or more publishing APIs 3060 to determine if that property is currently listed for sale on a publicly accessible platform. The backend polls the publisher regarding the status of the property. If and when a property is publically listed for sale, all buyers having included the property on their respective buyer lists are notified, either (i) via the server 3005 directly during review of their buyer list(s), or (ii) through Notification 3040, as previously described. A buyer may navigate directly to the public listing via a link incorporated into the notification. Some publishers may have limits on caching data and on rates of polling. Therefore, polling may be batched and/or staggered throughout the day, or implemented by some other paradigm.

To facilitate user engagement with the present platform, data flows between the server 3005 and a payment processor 3065. Payment processing is responsible for two services: registering payment information (e.g., credit card numbers), and processing payments. This service may be provided by a third-party service provider.

The present platform also may provide for deep linking 3025 in order to provide the present platform administrators with a 360 degree perspective on how the client applications are distributed and adopted in the market. Data flow between each of the client applications, the native mobile app 3010, the responsive web app 3015, and the deep linking 3025 service is shown. Each client application can communicate with the deep linking 3025 component to arrive at the perspective mentioned. One or more components of system 3000 may be integrated with each other without deviating from the scope of this disclosure.

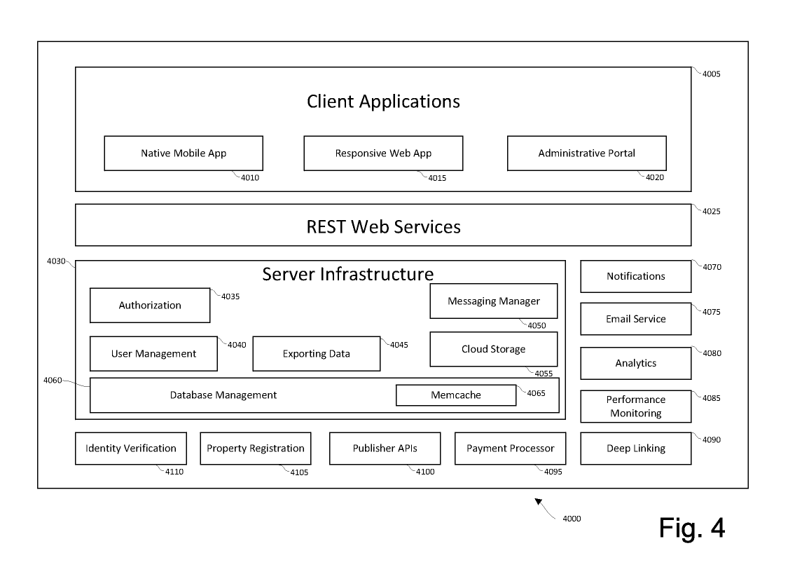

Turning to FIG. 4, server architecture diagram 4000 illustrates an exemplary embodiment of the present platform. Client applications 4005 contains a native mobile app 4010 for storage and executing on a mobile device, a responsive web app 4015 and an administrative portal 4020. The native mobile app 4010, for example iOS, may be implemented using, for example, XCode IDE with Swift as the programming language.

Representational State Transfer (REST) Web Services 4025 are implemented to handle data transfer and establish a simple protocol for the distributed media system of the present platform, such as may be used with a client/server architecture with mobile devices and centrally accessible server(s).

Server infrastructure 4030 shown in FIG. 4 comprises the authorization 4035 functionality, user management 4040 functionality, exporting data service 4045, messaging manager 4050 and cloud storage 4055 on which a client application (native mobile app or web app) may depend. While the authorization 4035 backend can support basic authorization for web service requests, the client applications 4005 may authenticate via authorization 4035 with a username/password combination for login, and a session token for all authorized requests. The backend may also be able to handle re-set/forgot password requests. User management 4040 is used to manage user accounts and user account administration, while the backend may store relevant information about users to create and update user profiles. User management 4040 and the administrative portal 4020, of the client applications 4005, may work in conjunction to keep bad actors off the present platform. The administrator(s) of the present platform may also be able to allow or deny users authority to perform certain tasks in, or access certain features of, the client applications.

Exporting data service 4045 may wrap up any data a user is looking to share via e-mail with someone outside the present platform. The data is wrapped up in a zip file and can be stored in cloud storage 4055. The messaging manager 4050 of the server infrastructure 4030 can be used to handle e-mail communication between two users. For example User A, such as an owner, initiates contact and e-mails User B, such as a buyer, within a client application 4005, to initiate a dialog with respect to a possible property transaction. The e-mail may be initiated by User A, with an anonymous e-mail address supplied by the present platform (either by the server 3005 of FIG. 3 of the present platform or the messaging manager 4050 of FIG. 4). Alternatively, the present platform may generate an e-mail addressed to a specific user, all users or some subset of users. The present platform has the capability to store e-mail messages on the server 3005 of FIG. 3 of the present platform or the messaging manager 4050 of FIG. 4; and the server acts as an anonymous proxy service until two users (such as an owner and a buyer) agree to exchange personal contact information.

Additionally, a database management 4060 manager maintains any data repository associated with the applications and the common interfaces to the database; all within the server infrastructure 4030. Aiding in the administration of the data, the database management 4060 includes a cache 4065 for the property capture system and functionality, where data may be stored until further actions are prompted, including, for example, deletion of a property from the cache 4065 or transfer to a buyer list. In another example, the backend may receive a query which may require the server infrastructure 4030 to verify whether the data needed to satisfy that query is in the cache 4065. If the data is in the cache 4065, the application uses that data. If the data is not in the cache 4065, the data management 4060 queries the data store and stores the results in the cache 4065 for future requests. The cache 4065 may or may not be a shared resource.

Additional functionality, as previously described in the data flows shown in FIG. 3, is incorporated into the system architecture 4000 diagram in FIG. 4, namely notifications 4070, e-mail service 4075, analytics 4080, performance monitoring 4085, deep linking 4090, payment processor 4095, publisher APIs 4100, property registration 4105, and identity verification 4110.

Each of the components depicted in the exemplary figures and described herein can be formatted as modules (serving the processes as described herein), whether as software, firmware or some combination thereof. They may be split up and scaled independently of one another. The components or portions thereof may be stored, operated on, distributed or executed by a client/server topology, a centralized server, or other decentralized arrangement.

While the invention has been described with respect to the foregoing, those skilled in the art will readily appreciate that various changes and/or modifications can be made to the invention without departing from the spirit or scope of the invention as defined by the appended claims.

We claim:

1. A computer-implemented method comprising:
receiving property identification data for properties from buyers via a client application;
creating a buyer list for each buyer that includes properties for which property identification data was received from the buyer;
receiving property registrations from owners of properties;
matching property identification data from the property registrations with property identification data from the buyer lists;
generating matching notifications;
transmitting the matching notifications to the owners of the matched properties, wherein each matching notification informs an owner of a buyer's interest in purchasing the owner's property; and
enabling e-mail communication, initiated by the owner, between the owner and the buyer.

2. The computer-implemented method of claim 1, wherein the properties are unlisted real properties, the unlisted real properties being one of residential, commercial, industrial or agricultural.

3. The computer-implemented method of claim 1, further comprising verifying the identity of the buyer.

4. The computer-implemented method of claim 1, further comprising verifying the identity of the owner.

5. The computer-implemented method of claim 1, wherein user ownership of a registered property has been verified.

6. The computer-implemented method of claim 1, wherein registration of properties is confidential.

7. The computer-implemented method of claim 6, wherein registered properties are not publicly searchable.

8. The computer-implemented method of claim 1, wherein e-mail communication between the owner and the buyer is anonymous and confidential.

9. The computer-implemented method of claim 1, wherein the buyer lists are confidential.

10. The computer-implemented method of claim 1, wherein the matching notifications serve as a decision catalyst for the owner to sell his or her property.

11. The computer-implemented method of claim 1, wherein the property identification data is GPS-generated geographical coordinates for a property.

12. The computer-implemented method of claim 11, wherein the client application executes on a GPS-enabled mobile electronic device.

13. The computer-implemented method of claim 1, wherein the property identification data is a physical address.

14. The computer-implemented method of claim 13, wherein the property identification data was manually entered via a client application.

15. The computer-implemented method of claim 1, wherein the matching of property identification data is performed by a server.

16. The computer-implemented method of claim 1, wherein matching notifications are e-mail messages.

17. The computer-implemented method of claim 16, wherein matching notifications are anonymous and confidential.

18. The computer-implemented method of claim 1, further comprising generating a database of registered properties and properties included on buyer lists.

19. The computer-implemented method of claim 1, wherein the e-mail communication between an owner and a buyer facilitates discreet price discovery for the benefit of the owner.
